(19) United States
(12) Patent Application Publication
(10) Pub. No.: US 2006/0131519 A1
(43) Pub. Date: Jun. 22, 2006

(54) Film scanner and a scanning method for suppressing brightness variations of a radiation source

(75) Inventors: Mathias Uhlig, Berlin (DE); Andreas Eckardt, Berlin (DE); Michael Neidhardt, Erkner (DE)

Correspondence Address: COHEN, PONTANI, LIEBERMAN & PAVANE, 551 FIFTH AVENUE, SUITE 1210, NEW YORK, NY, 10176, US

(73) Assignee: Deutsches Zentrum fur Luft- und Raumfahrt e.V.

(21) Appl. No.: 11/282,781

(22) Filed: Nov. 18, 2005

(30) Foreign Application Priority Data
Nov. 19, 2004 (DE) 10 2004 056 722.0

(51) Int. Cl. G01N 21/86; G01V 8/00

(52) U.S. Cl. 250/559.01

(57) ABSTRACT

A film scanner for digitizing a film includes a stabilized radiation source producing light, a film stage on which the film to be digitized is guided, a projection lens, and a photosensitive sensor. Light passing through the film to be digitized is projected by the projection lens onto the photosensitive sensor when the film is on the film stage, and the film is converted to digital image data by the photosensitive sensor. The film scanner also includes a photosensitive reference sensor arranged for determining brightness measurement values and brightness variations of the radiation source.

### BACKGROUND OF THE INVENTION

The invention relates to a film scanner and a scanning method for suppressing brightness variations of a radiation source.

In a film scanner, a piece of film is conducted across a film stage so that it passes by a radiation source. The light from the radiation source illuminates a section of the film. A projection lens projects the illuminated section of the film onto a photosensitive sensor, which digitizes the image. CCD or CMOS sensors in the form of rows or row-and-column arrangements or other photosensitive arrangements are used.

One area of application for film scanners is the digitizing of films for archival purposes. When scientific images are digitized, the digitized result must be as free of data loss as possible. To obtain the radiometric information present in film images with the minimum of data loss, a radiometric resolution of 12 bits is required. That is, the brightness values must be scanned with a scanning depth of at least 12 bits (0.02%). This scanning of the brightness values is affected by variations in the brightness of the radiation source.

High quality radiation sources now available (e.g., HQI, xenon, and halogen light sources) offer large quantities of light. However, the brightness of these light sources varies by about 0.3-1% and therefore the constancy of the light is limited. The brightness variations are caused chiefly by voltage variations in the voltage supply of the radiation source and also by thermal changes in the environment of the radiation source. Very good voltage supplies have a residual ripple of approximately 0.1%. This, however, is enough to cause brightness variations of approximately 0.3% in the radiation source. Alternatively or additionally, there is the possibility of regulating the current supplied to the radiation source. Every automatic control circuit, however, has a control time constant, which means that brightness variations can still occur even when current-controlled radiation sources are used.

### SUMMARY OF THE INVENTION

An object of the present invention is to provide a film scanner and a scanning method which, when used to digitize film, supply data which contain nearly all of the radiometric information.

The object of the present invention is met by a film scanner for digitizing a film having a film stage on which the film to be digitized is guided, a radiation source producing light for illuminating the film to be digitized when the film is on the film stage, a projection lens, and a photosensitive sensor. Light passing through the film to be digitized is projected by the projection lens onto said photosensitive sensor when the film is on the film stage and the film is converted to digital image data by the photosensitive sensor. The film scanner also includes a photosensitive reference sensor arranged for determining brightness measurement values and brightness variations of the radiation source.

The object is also met by a scanning method for suppressing brightness variations of a radiation source during digitizing of film by a film scanner including the steps of producing light using the radiation source, illuminating sections of the film conducted across a film stage using the produced light, using a projection lens to project the light which passes through the film onto a photosensitive sensor, digitizing the projected illuminated sections of the film and thus producing digital image data, and measuring brightness variations and brightness measurement values of the radiation source using a reference sensor.

When a piece of film is scanned, the film is conducted across a film stage past a radiation source. The radiation source produces light, by means of which sections of the film are illuminated, and a projection lens is used to project the image onto at least one photosensitive sensor. The photosensitive sensor digitizes the projected, illuminated sections of the film. Digital image data are thus produced. A photosensitive reference sensor measures the brightness variations of the radiation source and determines brightness measurement values. This offers several advantages. The digital image data and the brightness measurement values contain the complete set of radiometric information contained in the film and can be easily archived. In addition, the brightness measurement values are used to correct or to normalize the digital image data with respect to the brightness of the radiation source. On the basis of the brightness measurement values, it is also possible to evaluate the quality of the radiation source. As a result, it is possible to obtain early warning of any damage which may be present, such as damage to the voltage supply or to the current controller of the radiation source. It is thus also possible quickly to detect problems in the environment of the radiation source such as temperature fluctuations which may occur during the scanning process and which may cause changes in the brightness of the radiation source.

According to an embodiment of the present invention, a corrector is provided to correct the digital image data on the basis of the determined brightness measurement values. Corrected or normalized digital image data are thus obtained, which can be sent on for further processing and evaluation. The data concerning the differences in brightness in the corrected digital image data reflect information which is present in the scanned film. The corrected digital image data contain all of the information present in the scanned film. The brightness measurement values therefore do not have to be archived as well, which reduces the amount of storage capacity required.

In a further embodiment of the present invention, the photosensitive reference sensor constitutes part of the photosensitive sensor, which is preferably a linear sensor. This embodiment also offers the advantage that the brightness measurement values are produced synchronously with the digital image data. As a result, a one-to-one correspondence is obtained between the brightness measurement values and the digital image data, which greatly simplifies the correction of the digital image data. In addition, the brightness measurement values and the digital image data are in the same form from a measurement sensor, which also facilitates and accelerates further processing. Any systematic errors which may occur during digitizing—errors attributable to the photosensitive linear sensor—cancel each other out when the digital image data are normalized.

The radiation source, the projection lens, and the reference sensor are arranged such that part of the light from the radiation source can be projected by the projection lens onto the reference sensor without passing through the film first. It is advantageous for the light used for the brightness measurement to travel along the same path as the light which projects the section of the film onto the photosensitive sensor. In this way, changes in the projection lens act both on the digital image data and on the brightness measurement values. In addition, this leads to a compact design, because there is no need for the additional projection lens required in other embodiments to project the light of the radiation source onto the reference sensor.

To achieve a further increase in the radiometric resolution, it is desirable for both the photosensitive sensor and the reference sensor to be highly stable. This is achieved by temperature-stabilizing the sensors. According to an especially high-resolution embodiment of the invention, therefore, the photosensitive sensor and/or the reference sensor has a thermal stabilizer. If the sensors are cooled by the thermal stabilizers, the dark noise which occurs in CCD and CMOS linear arrays, for example, can be suppressed, which further increases the radiometric resolution.

The radiometric resolution can be improved even more by providing a dark noise corrector comprising a mean value calculator, which determines a reference value for the dark noise of the photosensitive sensor by calculating mean values of the dark noise measurements obtained from the unexposed pixels of the photosensitive sensor, and a subtractor, which subtracts the reference value of the dark noise from the digital image data.

The individual pixels of the photosensitive sensor usually have different sensitivities. A correction value can be determined in advance for each pixel by a process of pixel sensitivity calibration to compensate for the nonuniformity. To take into account the different sensitivities and to compensate for them, an elaboration of the invention thus provides a sensitivity corrector, comprising a memory, from which a previously known correction value can be called up for each pixel to correct for the nonuniform sensitivity of the pixels of the photosensitive sensor, and a multiplier for multiplying the previously known correction values by the digital image data.

When a pixelized sensor is used as reference sensor, an additional mean value calculator may be used, which determines a brightness reference value by calculating a mean value from the brightness measurements of several pixels of the reference sensor, along with an additional multiplier for multiplying the brightness reference value by the digital image data. This embodiment offers the advantage that several redundant measurement values for the brightness of the radiation source are measured. This increases the reliability of the determination of the brightness measurement values. In addition, this embodiment uses an especially simple correction procedure, according to which the digital image data are simply multiplied by the brightness reference value determined from the mean value of the brightness measurements. Such multiplications are easy to execute and are very precise.

The corrector is realized as software and/or as hardware. In a hardware embodiment, the corrected digital image data are available immediately. In addition, the brightness measurement values do not need to be archived along with the image data, which means that the amount of data to be stored is reduced. A software embodiment makes it possible to monitor the brightness variations after the fact. In addition, the scanner unit of the film scanner can be made more compact, because it does not need to accommodate any of the electronic components required for the correction work.

The features of the elaborations of the inventive scanning method offer the same advantages as the corresponding features of the film scanner.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic diagram of a film scanner;

FIG. 2 is a perspective view of a photosensitive linear sensor with a thermal stabilizer;

FIG. 3 is a graph which illustrates the calculated correction values for different measured brightness values of the radiation source; and

FIG. 4 shows a schematic diagram of a circuit for correcting measured digital image data.

### DETAILED DESCRIPTION OF THE PRESENTLY PREFERRED EMBODIMENTS

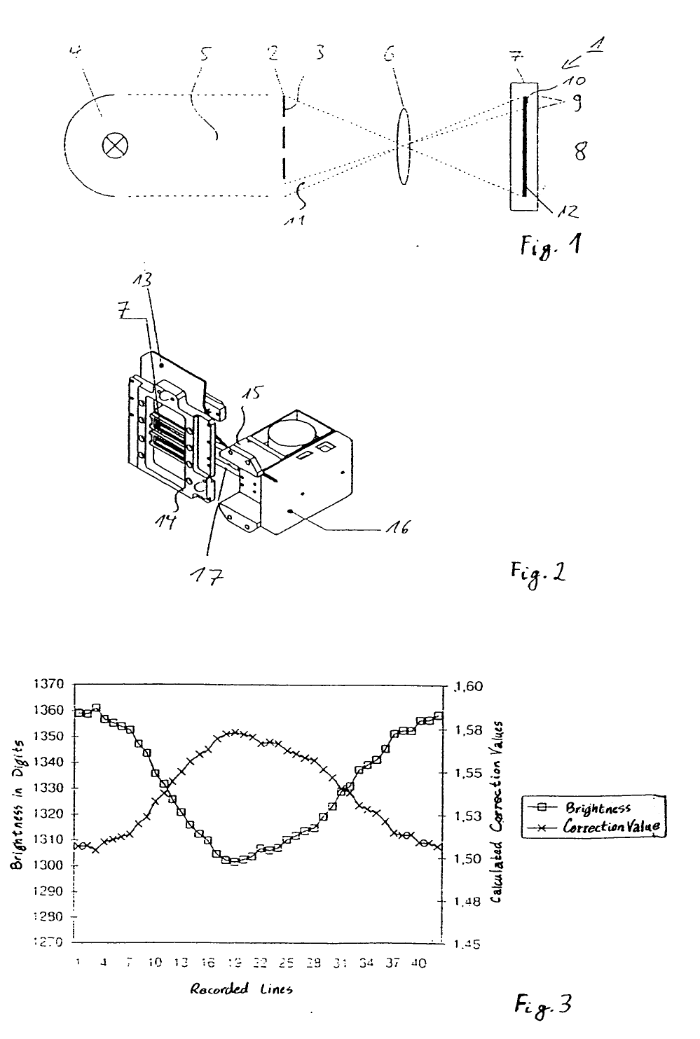

FIG. 1 is a schematic diagram of a film scanner 1. A piece of film 2 is conducted across a film stage 3 so that it passes by a radiation source 4. The radiation source 4 produces light 5, which illuminates a preferably linear section of the film 2. A projection lens 6 projects the illuminated section of the film 2 onto a photosensitive linear sensor 7. The photosensitive linear sensor 7 comprises a CCD or CMOS linear array 12 or some other type of photosensitive linear array. The photosensitive linear sensor 7 digitizes the projected illuminated section of the film 2 and thus generates digital image data.

The illuminated section of the film 2 is projected only onto the measurement section 8 of the photosensitive linear sensor 7, i.e., of the CCD or CMOS linear array 12. A reference section 9 of the photosensitive linear sensor 7 or of the CCD or CMOS linear array 12 serves as a photosensitive reference sensor 10. A portion 11 of the light 5 is projected by the projection lens 6 onto the reference sensor 10 without passing through the film 2. The reference sensor 10 measures the brightness values of the radiation source 4. The brightness measurement values determined by the reference sensor 10 and the digital image data together contain sufficient information to make it possible to store the film digitally with practically no data loss. Brightness variations of the radiation source 4 can be removed mathematically from the digital image data, which means that the brightness variations are suppressed.

FIG. 2 is a perspective view of a focal plane 14, on which are arranged several linear sensors 7. Each linear sensor 7 comprises a housing and at least one CCD or CMOS linear array. The focal plane 14 consists of a base body which is a good conductor of heat and which is compatible in terms of expansion with the housing of the linear sensors 7. The electronic circuitry 13 of the sensors is mounted behind the focal plane 14. The linear sensors 7 are preferably connected directly to the electronic circuitry 13. The focal plane 14 is connected to a thermal stabilizer 16, where for this purpose the thermal coupling is achieved, for example, by means of thermal conduction tubes 15, 17. All pixels of the photosensitive linear sensor 7 are at the same temperature, so that the thermally induced dark noise can be assumed to be the same for all of them. If the photosensitive linear sensor 7 is used in a film scanner according to FIG. 1, both the pixels of the reference section 9, which are assigned to the reference sensor 10, and the pixels of the measurement section 8, which are used to digitize the projected, illuminated section of the film 2, will be at the same temperature.

FIG. 3 is a graph, in which the average brightness values (shown as squares) of the reference section are plotted against the numbers of the recorded lines. It can be seen that the brightness of the radiation source modulates in the form of a sine wave. The calculated correction values (shown as crosses) are plotted against the numbers of the recorded lines. As the brightness of the radiation source increases, the correction value decreases, and vice versa.

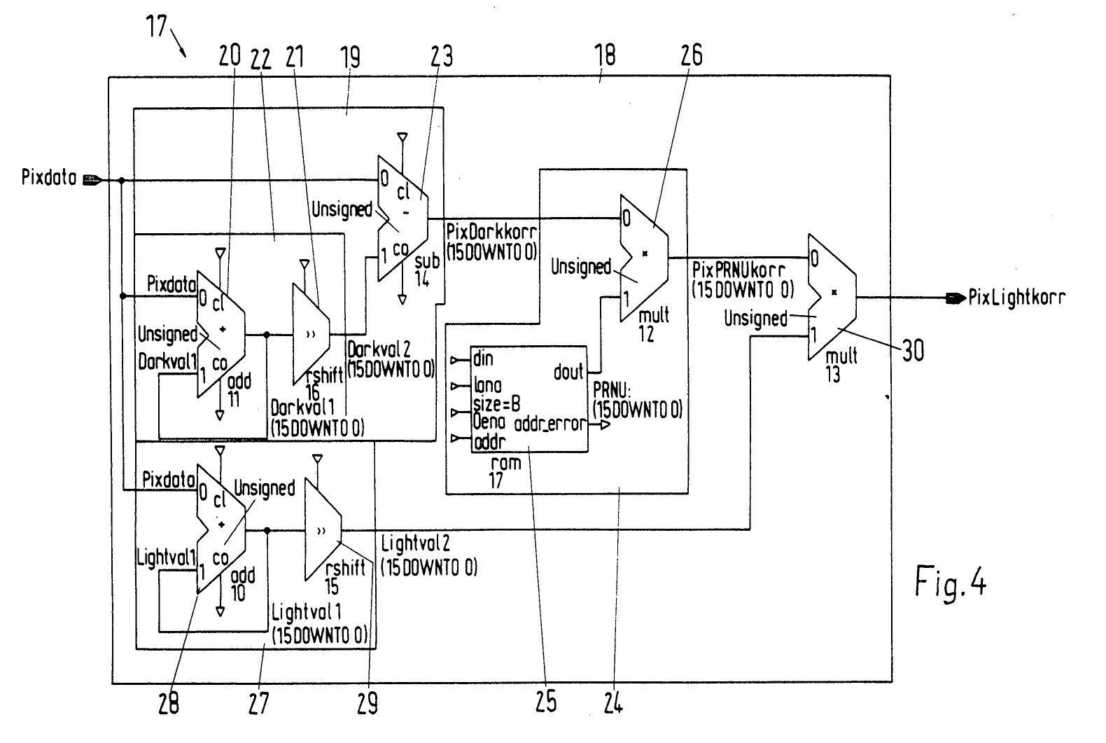

FIG. 4 is a schematic diagram of a circuit 17 for correcting the digital image data, i.e., the data which were digitized by the measurement section 8 of the film scanner 1 according to FIG. 1, with the help of a corrector 18. It is assumed here that the photosensitive linear sensor 7 has a dark noise reference section (not shown), in which the pixels are not exposed to light. The dark noise measurements which are measured by these covered pixels, for example, are processed by the dark noise corrector 19. This comprises an adder 20 and shift register 21, which work together to form a mean-value calculator 22. By forming mean values, a reference value is determined for the dark noise, which is then subtracted from the digital image data by a subtractor 23 of the dark noise corrector 19.

A difference obtained in this way is entered into a sensitivity corrector 24. This comprises a memory 25, in which previously determined, i.e., previously known, correction values for the non-uniform sensitivity of the pixels are stored in advance for each pixel of the measurement section 8. These are called up and multiplied in a multiplier 26 by the difference just obtained.

A product thus obtained is subjected to further processing in the corrector unit 18 together with the brightness measurement values of the pixels of the reference section 9. A mean value is calculated from the brightness measurements by means of an additional mean-value calculator 27, which consists of another adder 28 and another shift register 29. This mean value is used to determine a brightness reference value. The brightness reference value, which represents the correction value according to FIG. 3, is multiplied in another multiplier 30 by the obtained product to obtain digital image data in which the brightness variations of the radiation source 4 are suppressed.

If several spectral channels are used during the digitizing process, the film scanner 1 according to FIG. 1 can have a circuit 17 according to FIG. 4 for each spectral channel. Several spectral channels can be realized, for example, by installing various filters in front of the linear sensors 7.

The corrector 18 may be designed such that it comprises both the dark noise corrector 19 and the sensitivity corrector 24. The corrector 18 can be embodied partially or entirely as software or, as indicated in FIG. 4, completely as a hard-wired circuit.

In a departure from the previously described embodiment, the dark noise corrector 19 and the sensitivity corrector 24 can also be designed as separate circuits. In another embodiment, the reference sensor can be an independent photosensitive sensor separate from the photosensitive linear sensor. The light of the radiation source may, for example, be projected onto this independent photosensitive sensor by an optical fiber.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A film scanner for digitizing a film, comprising:
a film stage on which the film to be digitized is guided;
a stabilized radiation source producing light for illuminating the film to be digitized when the film is on said film stage;
a projection lens;
a photosensitive sensor, wherein light passing through the film to be digitized is projected by said projection lens onto said photosensitive sensor when the film is on said film stage, wherein the film is converted to digital image data by said photosensitive sensor; and
a photosensitive reference sensor arranged for determining brightness measurement values and brightness variations of said radiation source.

2. The film scanner of claim 1, further comprising a corrector for correcting the digital image data based on said determined brightness measurement values.

3. The film scanner of claim 1, wherein said photosensitive reference sensor is a part of said photosensitive sensor.

4. The film scanner of claim 1, wherein said radiation source, said projection lens, and said reference sensor are arranged such that a portion of the light produced by said radiation source which does not pass through the film to be digitized is projected by said projection lens onto said reference sensor when the film to be digitized is on the film stage.

5. The film scanner of claim 1, further comprising a thermal stabilizer connected to at least one of said photosensitive sensor and said reference sensor for stabilizing the temperature of said at least one of said photosensitive sensor and said reference sensor.

6. The film scanner of claim 1, further comprising a dark noise correction unit having a mean-value calculator for determining a reference value for dark noise of said photosensitive sensor, said mean-value calculator calculating the mean value of the dark noise measurements obtained from unexposed pixels of said photosensitive sensor to obtain the reference value for the dark noise, and a subtractor for subtracting the reference value of the dark noise from the digital image data.

7. The film scanner of claim 6, further comprising a sensitivity correction unit having a memory storing a previously known correction value for the nonuniform sensitivity of each pixel of said photosensitive sensor, and a multiplier for multiplying the previously known correction values by the digital image data for a respective pixel.

8. The film scanner of claim 7, further comprising an additional mean-value calculator for determining a brightness reference value by calculating a mean value from the brightness measurements of several pixels of said reference sensor and an additional multiplier for multiplying the brightness reference value by the digital image data.

9. The film scanner of claim 1, further comprising a sensitivity correction unit having a memory storing a previously known correction value for the nonuniform sensitivity of each pixel of said photosensitive sensor, and a multiplier for multiplying the previously known correction values by the digital image data for a respective pixel.

10. The film scanner of claim 1, further comprising a mean-value calculator for determining a brightness reference value by calculating a mean value from the brightness measurements of several pixels of said reference sensor and a multiplier for multiplying the brightness reference value by the digital image data.

11. The film scanner of claim 2, said corrector is implemented using at least one of software and hardware.

12. A scanning method for suppressing brightness variations of a radiation source during digitizing of film by a film scanner, said method comprising the steps of:
producing light using the radiation source;
illuminating sections of the film conducted across a film stage using the produced light;
projecting, by a projection lens, the light which passes through the film onto a photosensitive sensor;
digitizing the projected illuminated sections of the film and thus producing digital image data; and
measuring, by a reference sensor, brightness variations of the radiation source and determining, by the reference sensor, brightness measurement values of the radiation source.

13. The scanning method of claim 12, further comprising the step of correcting digital image data based on the determined brightness measurement values.

14. The scanning method of claim 12, wherein said step of measuring brightness variations and determining brightness measurement values includes the step of projecting, by the projection lens, a portion of the light produced by the radiation source onto the reference sensor without passing through the film.

15. The scanning method of claim 12, wherein said step of measuring brightness variations and determining brightness measurement values includes the step of projecting, by a photoconducting lens, a portion of the light produced by the radiation source onto the reference sensor.

16. The scanning method of claim 12, further comprising the step of thermally stabilizing at least one of the photosensitive sensor and the reference sensor.

17. The scanning method of claim 12, wherein said step of digitizing and said step the measuring of the brightness variations are performed simultaneously by the photosensitive sensor.

18. The scanning method of claim 13, wherein said step of correcting the digital image data takes into account both a dark noise of the photosensitive sensor and a nonuniform sensitivity of pixels of the photosensitive sensor.

19. The scanning method of claim 18, wherein the digital image data comprise several spectral channels and the digital image data of each spectral channel are corrected by:
determining a brightness reference value by calculating a mean value of the brightness measurements of several pixels of the reference sensor;
determining a reference value for the dark noise of the photosensitive sensor by calculating a mean value from the dark noise measurements of unexposed pixels of the photosensitive sensor;
subtracting the reference value of the dark noise from a digital image data value for each pixel of the digital image data;
multiplying the difference between the reference value of the dark noise and the digital image data value by a correction value for the nonuniform sensitivity of the pixels of the photosensitive sensor, this correction value already being known for each pixel and retrieved from a memory; and
multiplying the product obtained from the step of multiplying for each pixel by the brightness reference value.

20. The scanning method of claim 13, wherein the digital image data are corrected by at least one of software and hard-wired electronic circuitry.
